(19) United States
(12) Patent Application Publication
(10) Pub. No.: US 2021/0356348 A1
(43) Pub. Date: Nov. 18, 2021

(54) System and Method for Leak Detection

(71) Applicants: George M. Solomon, Oak Ridge, TN (US); Mark D. Boeckmann, Oak Ridge, TN (US)

(72) Inventors: George M. Solomon, Oak Ridge, TN (US); Mark D. Boeckmann, Oak Ridge, TN (US)

(21) Appl. No.: 16/876,455

(22) Filed: May 18, 2020

(51) Int. Cl. G01M 3/02

(52) U.S. Cl. CPC G01M 3/02

(57) ABSTRACT

A system for detecting gas leaks in a gas-containing component includes: a test gas comprising molecular hydrogen introduced on one side of a gas-containing component; a vacuum pump to collect a gas sample from the other side of the gas-containing component; a hydrogen detector to receive the gas sample and determine the hydrogen content therein; and, a trap containing a regenerable sorbent material upstream from the hydrogen detector, the sorbent material characterized by having less affinity for molecular hydrogen than for heavier hydrogen-containing molecular species. Regeneration of the sorbent may be accomplished by exposure to purge gas, or by exposure to a lower total pressure than existed during the test cycle.

### BACKGROUND OF THE INVENTION

### Field of the Invention

The invention pertains to apparatus and methods for leak detection and more particularly to systems in which hydrogen or various refrigerants are the test gas.

### Description of Related Art

In the field of leak detection, it is common for helium to be used as a test gas, primarily because its natural abundance in air is very low and it can easily be detected. A selected pressure of helium is maintained on one side of a pressure envelope to be tested for leak-tightness, and any He appearing on the other side is detected, typically by ionization/mass spectrometry. Many configurations of tests are known in the industry. In one example, a component is filled with He and then placed into a vacuum chamber. The chamber is actively pumped, and the He detector is placed upstream from the pump, to detect He leaking from the test component. In another example, a component may be pressurized with He to above atmospheric pressure, and a small “sniffer” wand is manually moved around the outside of the component to check for leakage at fittings, braze joints, and the like. The sniffer is backed up by a vacuum pump and upstream He detector.

However, there are periodic concerns about the long-term supply and cost of He, and one potential solution to this problem would be to substitute hydrogen as the test gas, because simple adjustments to existing He detectors would allow H₂ to be easily detected. An alternate solution would allow for a refrigerant detector to replace an existing He detector.

Attempts to do this, however, have suffered from the fact that, in contrast to He, many hydrogen-containing species can be present in the test environment. These include water, hydrocarbons (particularly traces of oil), ammonia, chlorofluorocarbons, and so on. All of the aforementioned species, particularly water, create such a high background signal that many false positive results are indicated, making the method impractical in a production environment. Specifically, the elevated background signal might limit the ultimate sensitivity to above the desired measurement range or limit the speed at which the measurement can be achieved for a desired sensitivity.

There are other leak detection systems that use test gas other than He that are prone to interference problems. These include measuring various refrigerants as a trace gas. It is common in the trade to use refrigerant in leak testing, and in certain applications a refrigerant detector could be installed in the place of a He detector. Here again, the challenge is to enhance the refrigerant signal to be measured.

U.S. Pat. No. 2,671,337, to Hulsberg, describes the analysis of H₂ in a flowing gas by measuring H₂ permeating through a long, thin tube of palladium or platinum.

U.S. Pat. No. 2,863,315, to Penning, describes a leak detector having a chilled adsorbing medium between a H₂ or He detector and the part being leak checked. It is claimed that silica gel is preferable to activated carbon if H₂ is used as the test gas, whereas either medium can be used with He. LN₂ is identified as a cooling means.

U.S. Pat. No. 3,227,872, to Nemeth, describes a gettering chamber with Ti sublimation used to remove reactive gases to improve detection of noble tracer gases.

U.S. Pat. No. 3,342,990, to Barrington et al., describes the use of a sorption pump at LN₂ temperatures as a gas filter in front of a mass spectrometer. The sorption pump is used as a capture pump, i.e., a cryo cold trap, so the system will need to be shut down when the cryo pump is regenerated. The long cycle time needed to bake out a cryopump makes this approach impractical in many high throughput leak testing environments.

U.S. Pat. No. 4,409,817, to Edwards, discloses a moisture trap and pressure gauge to check for leaks using He or CO₂ as the test gas. The trap removes moisture, either by freezing or by adsorption on a material such as activated alumina, molecular sieves, and silica gel. A “sensitive low pressure gauge” is used to determine pressure of the test gas.

U.S. Pat. No. 5,304,796, to Siefering et al., teaches the use of a silica gel bed to dry gas before feeding an atmospheric pressure ionization mass spectrometer (APIMS) for the purpose of assaying the purity of a gas sample. The silica gel bed is dried between tests by flowing dry nitrogen while baking the silica gel for 1 to 4.5 h at 150-200° C. The detector is taught to be an APIMS because this method is widely used in the semiconductor industry for assuring the continued purity of ultra-high purity process gas. The disclosure does not address other applications, particularly leak detection.

U.S. Pat. No. 5,932,797, to Myneni, discloses a sensitive H₂ leak detector using a getter operating at cryogenic temperatures (77.5 K) and a residual gas analyzer as a quantitative hydrogen sensor. The getter is described as a SORB-AC hydrogen getter pump intended to remove hydrogen from the system.

U.S. Pat. No. 6,079,252, to Tabler et al, discloses a method for leak checking a vessel by placing a sensor near the vessel. The sensor may have adsorbent on a crystal detector to measure a change in mass or another characteristic. The vessel may contain adsorbent to hold gas.

U.S. Pat. No. 6,279,384, to Heikkinen et al., discloses a precharge H₂ test for soft and hard packages. The package is placed in a pressurized chamber of a test gas. Outgassing is then measured by accumulation in a chamber.

U.S. Pat. No. 6,401,465, to Meinzer, is directed to leak testing of an adsorption chiller. A H₂ sensor is protected from water vapor by a membrane that allows light gases to pass but blocks water vapor. Alternatively, a dehumidifying condenser is also disclosed.

U.S. Pat. No. 9,176,021, to Patel et al., describes hydrogen leak detection with MOS type gate/palladium catalyst. A particle filter in front of the detector is used to remove dust particles from the gas.

U.S. Pat. Appl. Pub. 2007/0157704 to Jenneus, teaches a system that includes a chamber to hold an object to be tested for leak tightness using H₂ as the test gas.

U.S. Pat. Appl. Pub. 2008/0307858, to McManus et al., describes a leak detector in which a gas cylinder, for example, may be placed for quality assurance testing of leak tightness.

U.S. Pat. Appl. Pub. 2009/0277249, to Polster et al., teaches a charge in chamber type test with a sample loop, and a detector in a chamber of the sample loop.

U.S. Pat. Appl. Pub. 2010/0095745, to Flynn et al., describes a “mass filter”, which may be a turbo pump, a permeable membrane, or a heated quartz membrane (which is said to have high permeability to He gas at temperatures in the range of 300-900° C.).

U.S. Pat. Appl. Pub. 2012/0153360, to Patel et al., describes a H₂ detector using a MOS type gate/palladium catalyst. Regeneration is of the electronic signal.

U.S. Pat. Appl. Pub. 2016/0116364, to Vaccaro et al., describes a H₂ charge in chamber test at atmospheric pressure, for testing a compressed gas tank.

U.S. Pat. Appl. Pub. 2016/0178472, to Watanabe et al., describes an accumulation detection improvement by using an accumulation chamber inside another chamber to boost the signal.

U.S. Pat. Appl. Pub. 2016/0223424, to Hilgers et al., describes a high flow/low flow sniffer arrangement, with a mass spectrometer to analyzing H₂ or He.

U.S. Pat. Appl. Pub. 2018/0073955, to Ducimetier et al, describes a filter of a mono-atomic layer of graphene with molecule size holes upstream of a leak detector.

What is needed, therefore, is a leak detection system that improves repeatability and reliability of test, sensitivity of test, and speed of test, without the need for cryogenic systems and the associated long regeneration cycle.

Objects and Advantages

Objects of the present invention include the following: providing a leak detector using hydrogen as the test gas while avoiding interferences from water vapor; providing a leak detector in which selected chemical trapping media remove interfering gas/vapor species from a stream going to a leak detection instrument; providing a leak detector with a regenerable chemical trap that absorbs selected hydrogen-containing species in preference to absorbing molecular hydrogen; providing a hydrogen leak detector suitable for use in a humid or contaminated environment; and, providing a technique for the rapid regeneration of a chemical trap to accommodate the typical short cycle times of chamber style leak detection systems.

Further objects of the present invention include the following: providing a leak detector using refrigerant as the test gas while avoiding interferences from water vapor; providing a leak detector in which selected chemical trapping media remove interfering gas/vapor species from a stream going to a leak detection instrument; providing a leak detector with a regenerable chemical trap that absorbs selected hydrocarbon-containing species in preference to absorbing a test gas; providing a refrigerant leak detector suitable for use in a humid or contaminated environment; and, providing a technique for the rapid regeneration of a chemical trap to accommodate the typical short cycle times of chamber style leak detection systems. These and other objects and advantages of the invention will become apparent from consideration of the following specification, read in conjunction with the drawings.

### SUMMARY OF THE INVENTION

According to one aspect of the invention, a system for detecting gas leaks in a gas-containing component, comprises:

a test gas comprising molecular hydrogen introduced on one side of a gas-containing component;

a vacuum pump to collect a gas sample from the other side of the gas-containing component;

a hydrogen detector to receive the gas sample and determine the hydrogen content therein; and,

a trap containing a regenerable sorbent material upstream from the hydrogen detector, the sorbent material characterized by having less affinity for molecular hydrogen than for other hydrogen-containing molecular species.

According to another aspect of the invention, a method for detecting leaks comprises the steps of:

a) introducing a test gas comprising molecular hydrogen on one side of a gas-containing component;

b) using a vacuum pump to collect a gas sample from the other side of the gas-containing component;

c) passing the gas sample through a trap containing a regenerable sorbent material, the sorbent material characterized by having less affinity for molecular hydrogen than for other hydrogen-containing molecular species, so that the concentration of the other species are reduced relative to the concentration of molecular hydrogen; and,

d) passing the gas sample from the trap to a hydrogen detector.

According to another aspect of the invention, a system for detecting gas leaks in a gas-containing component, comprises:

a test gas comprising a selected refrigerant introduced on one side of a gas-containing component;

a vacuum pump to collect a gas sample from the other side of the gas-containing component;

a refrigerant detector to receive the gas sample and determine the test gas content therein; and, a trap containing a regenerable sorbent material upstream from the detector, the sorbent material characterized by having less affinity for the selected refrigerant than for other interfering molecular species.

According to another aspect of the invention, a method for detecting leaks comprises the steps of:

a) introducing a test gas comprising a selected refrigerant on one side of a gas-containing component;

b) using a vacuum pump to collect a gas sample from the other side of the gas-containing component;

c) passing the gas sample through a trap containing a regenerable sorbent material, the sorbent material characterized by having less affinity for the selected refrigerant than for other interfering molecular species, so that the concentration of the other species are reduced relative to the concentration of the selected refrigerant; and,

d) passing the gas sample from the trap to a refrigerant detector.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting embodiments illustrated in the drawing figures, wherein like numerals (if they occur in more than one view) designate the same elements. The features in the drawings are not necessarily drawn to scale.

FIGS. 1A-B illustrate one example of the present invention. FIG. 1A shows the direction of gas flow during sampling. FIG. 1B shows the direction of gas flow during regeneration.

FIGS. 2A-B illustrate another example of the present invention. FIG. 2A shows the direction of gas flow during sampling through trap 1 while regenerating trap 2. FIG. 2B shows the direction of gas flow during sampling through trap 2 while regenerating trap 1.

FIGS. 3A-B illustrate another example of the present invention. FIG. 3A shows the direction of gas flow during sampling. FIG. 3B shows the direction of gas flow during regeneration.

FIGS. 4A-B illustrate another example of the present invention. FIG. 4A shows the direction of gas flow during sampling. FIG. 4B shows the direction of gas flow during regeneration.

FIGS. 5A-B illustrate another example of the present invention. FIG. 5A shows the direction of gas flow during sampling. FIG. 5B shows the direction of gas flow during regeneration.

FIGS. 6A-B illustrate another example of the present invention. FIG. 6A shows the direction of gas flow during sampling through trap 1 while regenerating trap 2. FIG. 6B shows the direction of gas flow during sampling through trap 2 while regenerating trap 1.

FIG. 7 provides a legend defining the various process components appearing in the schematic diagrams of FIGS. 1-6.

FIG. 8 illustrates schematically a two-stage trap, in which a first material selectively adsorbs a first interfering species and a second material selectively adsorbs a second interfering species in accordance with some aspects of the invention.

FIG. 9 illustrates schematically another two-stage trap in accordance with other aspects of the invention.

### DETAILED DESCRIPTION OF THE INVENTION

The invention relies on the principle that various sorbent materials may selectively take up water, ammonia, and hydrocarbons in preference to molecular hydrogen (or refrigerant). By stripping out such interfering species from the gas flow to a detector, the background signal can be significantly reduced to the point that substitution of hydrogen or refrigerant for helium becomes practical for many leak detection applications. The invention further lies in the discovery that such sorbents can be regenerated, and several suitable means for rapid regeneration are disclosed.

Examples of several different configurations are shown in the drawing figures, which will be described in further detail in the illustrative examples that follow. In the figures, the trap is typically shown as a container of beads, although the invention is not limited to any particular form factor, particle size, or other macroscopic physical characteristic of the sorbent material. The sorbent may be regenerated by applying a vacuum to it, by passing dry gas over it, or some combination thereof. In some examples it will be shown that two traps may be used alternately, so one trap can be regenerated while the other is working, thereby allowing optimization among repeatability and reliability of test, sensitivity of test, and speed of test.

Applicant also contemplates that the inventive trapping method may be adapted for sniffing leak detection which employs a continuous sampling process. To achieve this, switching between alternating chemical traps, with one in process, while the other is in regeneration mode, is required. Greatly reducing the concentration of the interfering gas/vapor getting to the leak detection instrument yields lower background levels and minimizes false failures just above the reject point.

Helium is often used as the tracer gas in leak detection applications where a mass spectrometer typically is used as the means of detection. The mass spectrometer's operating principle consists of ionizing a gas sample in a vacuum and accelerating the various ions through electrical and/or magnetic fields where the ions of interest are separated from other ions in the sample on the basis of their mass-to-charge ratio. The filtered ions arrive at the detector and the resulting ion current is correlated to the quantity of the species of interest that was present in the gas sample. In leak detection a specialized mass spectrometer (commonly referred to as a helium leak detector) is used where the hardware design, electronics, and operating parameters are optimized to ionize, filter, and detect helium in the gas sample with high sensitivity, eliminating interference from other species that might be present in the gas sample. With minor changes in operating parameters, a helium leak detector can be “tuned” to detect hydrogen. The ability to convert a leak detection system from helium tracer gas to hydrogen tracer gas is attractive when helium is in short supply or when helium is not available. However, when water vapor is present in the gas sample, it can dissociate to hydrogen and oxygen during the ionization process and this will create an elevated signal at the detector when it is tuned to detect hydrogen. The resulting hydrogen signal at the detector is typically dominated by the contribution from water and this makes high sensitivity detection of hydrogen tracer gas problematic. The invention disclosed herein strips the water vapor (and other contaminants that might also interfere) from the sample gas stream prior to ionization in the mass spectrometer in order that high sensitivity detection of hydrogen tracer gas is possible with a conventional helium leak detector.

The invention is not limited to hydrogen detection via mass spectrometry, but may also be usefully employed in systems designed to detect refrigerant gases by infrared techniques. Infrared (IR) leak detection is a method in which IR light is emitted and passed through a gas sample before arriving at an IR detector. Refrigerant in the gas sample absorbs some of the IR energy in a known band of wavelengths, and the degree of change in absorbed IR energy in this band of wavelengths is indicative of the change of refrigerant concentration in the gas sample. Filtering of the IR source is designed to remove as much “out-of-band” energy as possible, such that the remaining IR beam is predominately of wavelengths that interact strongly with the gas of interest. This increases the signal-to-noise ratio and decreases the likelihood of false readings. However, some of the out-of-band IR energy interacting with the sample gas can be absorbed by non-refrigerant compounds in the sample gas (such as water vapor, carbon dioxide, organic vapors, etc.). This out-of-band IR energy can potentially be re-radiated in-band and arrive at the IR detector. Any significant variation in these extraneous compounds can cause variations in the IR energy seen by the detector and cause a false response. The invention disclosed herein strips the water vapor and other contaminants that might interfere with the IR detection scheme from the sample gas stream. This can improve the sensitivity and accuracy of the IR refrigerant leak detector.

As used herein, the term interfering gases refers to any gaseous species that will be detected by whatever process is being used to detect the test gas (mass spectroscopy, IR absorption, etc.). Generally speaking, interfering gases that are likely to occur in a normal testing environment are almost always heavier molecules than the test gas. For example, interfering gases such as water, ammonia, and hydrocarbons all have molecular structures that are more readily adsorbed on a porous surface. Similarly, in an IR-based test for a refrigerant gas, interfering species tend to be traces of pump lubricants, cutting oils, and liquid solvents, which tend to have molecular structures that absorb IR with the same characteristics as the refrigerants. Many of these species can be readily captured by an appropriate sorbent. This led to Applicant's insight that sorptive traps can selectively remove interfering gases, and that for the specific case of moisture as an interfering gas to hydrogen, it might be possible to create a regenerable trapping system operating completely at ambient temperature.

Those skilled in the art of leak detection will appreciate that leak detection processes may be designed to measure leakage into or out of a putatively leak-tight component under test. When applicants refer to “one side” or “the other side” of a component, this means respectively the inside or the outside of the vacuum envelope.

### EXAMPLE

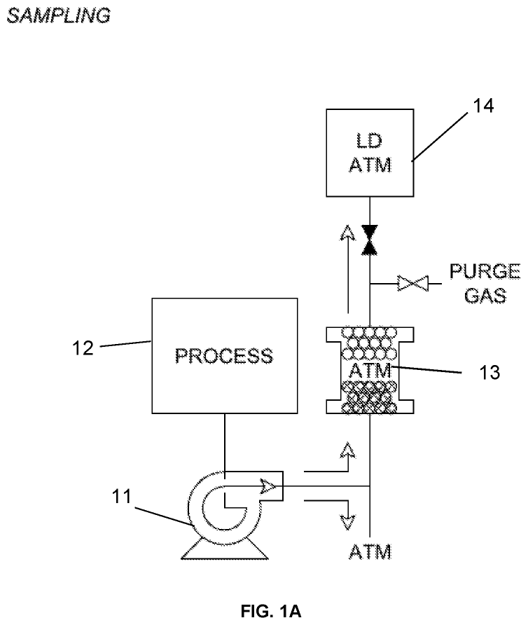

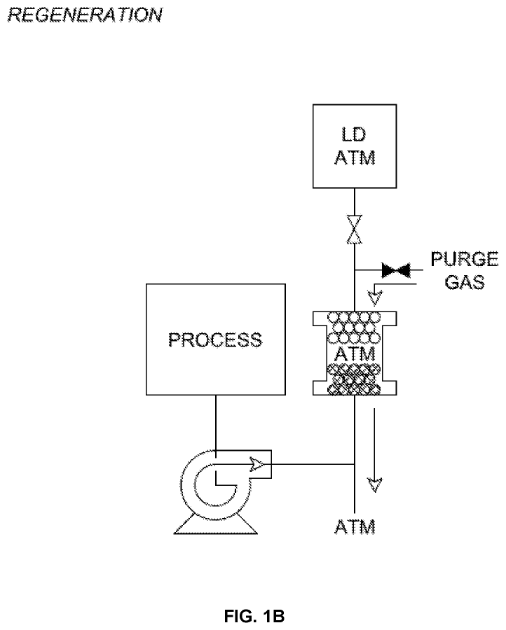

The system shown generally in FIG. 1 may be described as follows: During a sampling run, FIG. 1A, a vacuum pump 11 extracts gas from a process chamber 12. The exhaust stream is split, with some flow discharging to atmosphere and a sample stream passing through a sorbent bed (or trap) 13 and into an atmospheric pressure leak detector 14 configured to detect H₂. Assuming that H₂ is used as the tracer gas, any leak in the process will introduce small amounts of H₂ into the gas stream that exits the pump, and the quantity of H₂ detected will define the presence or severity of a leak. Traces of moisture, organics, or other interfering species that may exist in the process environment are adsorbed by the sorbent bed, minimizing any false signal attributed to the presence of hydrogen from these sources.

This configuration was also used with refrigerant as the test gas, with the results summarized in a later example presented herein.

During the regeneration phase, FIG. 1B, the valve to the leak detector is closed and the purge gas valve is opened. The purge gas is a “clean and dry” gas containing little, or none, of the interfering species. Purge gas flows through the sorbent to desorb the adsorbed interfering species and carry them to atmosphere as shown.

### EXAMPLE

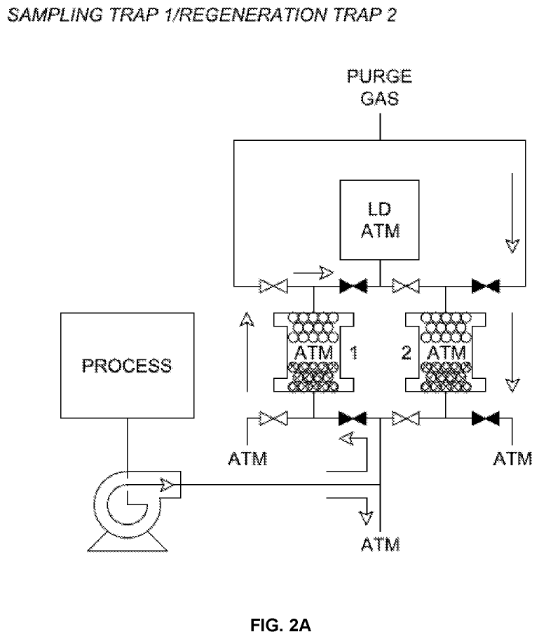

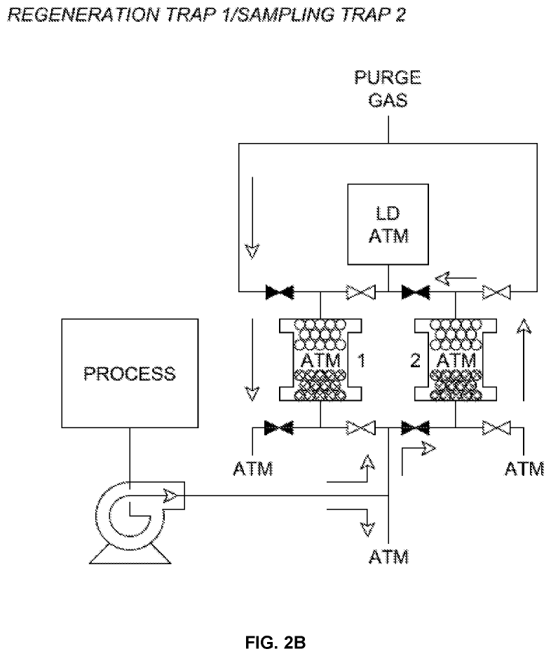

The system shown generally in FIG. 2 is intended for higher-throughput testing. The apparatus in this case is provided with two sorbent beds 1, 2 arranged in parallel so that one sorbent bed may be regenerated while the other bed is in use making a test. During any particular sampling run, the gas flow from the process to the leak detector is generally the same as previously described in FIG. 1A with respect to the active sorbent bed, and the purge gas flow is generally the same as previously described in FIG. 1B with respect to the regenerating sorbent bed.

FIG. 2A shows the flow paths for a run in which the sample stream is passing through trap 1 while trap 2 is being regenerated. FIG. 2B shows the flow paths for the next run, in which the sample stream is passing through trap 2 while trap 1 is being regenerated.

It will be appreciated that the system described in the foregoing example is well suited to leak testing in a production environment where it is contemplated that many identical parts will be tested one at a time. The cycling of each trap from test mode to regeneration mode will typically be automated as part of the overall system control programming. It will be further appreciated that the system may contain any number of traps arranged in parallel, so that regeneration time does not limit the test cycle time. This might be particularly important when working in an unusually humid environment, for example.

### EXAMPLE

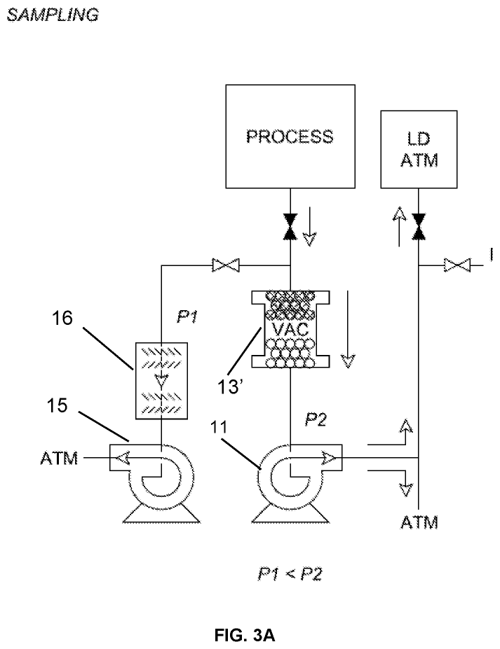

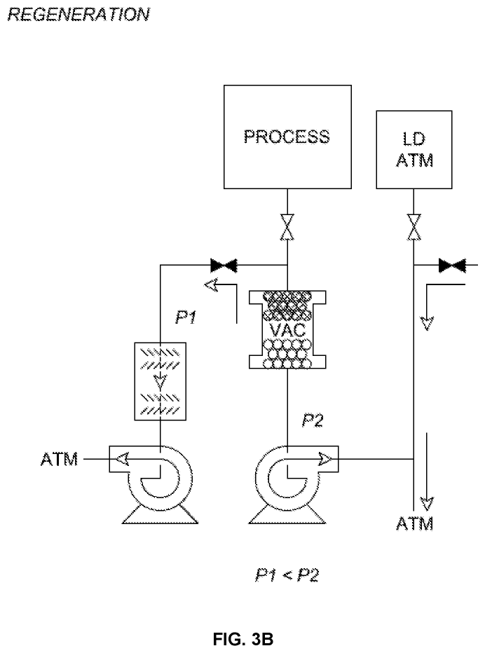

The system shown generally in FIG. 3 may be described as follows: The trap 13′ in this case is placed between the process and the main pump 11, and a second pump circuit, comprising a mechanical pump 15 and a turbomolecular pump 16, is used instead of dry purge gas to regenerate the trap. The trap, in this case, is operating under vacuum rather than at atmosphere. Again, an atmospheric leak detector is used.

As shown in FIG. 3A, during testing, the sample gas stream at pressure P₂ (P₂<Pₐₜₘ) passes from the process, through the trap to remove interfering species, then through the main pump and on to the leak detector. During regeneration, the valve to the leak detector is closed. The valve to the second pump circuit is opened, lowering the pressure in the trap from P₂ to P₁ and causing adsorbed species to desorb and pass out of the system via the turbomolecular pump. Exemplary values of P₁ range from about 0.1 to 0.5 Torr, and P₂ from about 1 to 5 Torr.

### EXAMPLE

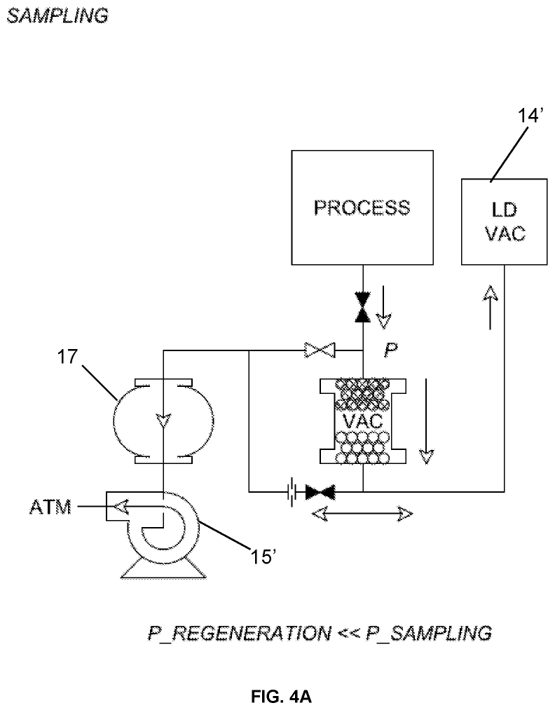

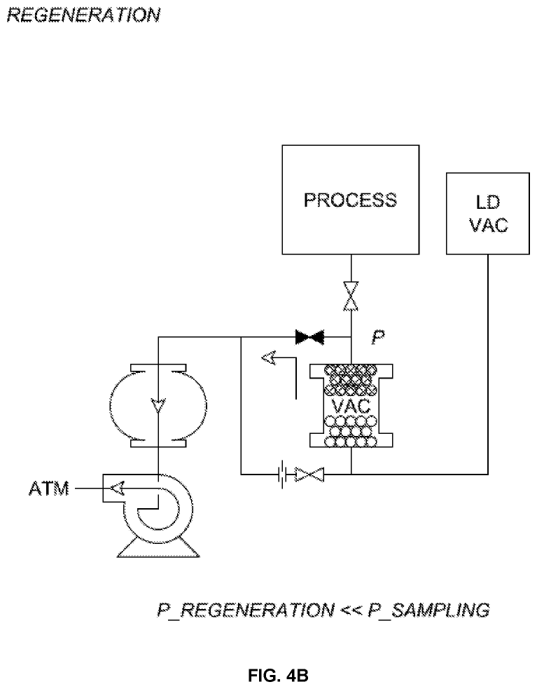

The system shown generally in FIG. 4 is configured for using a vacuum leak detector 14′. The pump circuit comprises a mechanical pump 15′ backing a rotary lobe vacuum blower 17. During sampling, FIG. 4A, sample gas passes through the trap and on to the vacuum leak detector. Pressure in this flow path, P_{sampling}, is maintained at a selected level by the orifice placed between the trap and the rotary lobe vacuum blower.

During regeneration, the trap is isolated from the process and a valve is opened allowing the rotary lobe blower to pump directly on the trap with no restricting orifice, reducing the pressure in the trap to P_{regeneration}<<P_{sampling}, so that adsorbed species will desorb and exit via the blower and vacuum pump. Exemplary values of P_{sampling} range from about 1 to 5 Torr, and P_{regeneration} from about 0.1 to 0.5 Torr.

### EXAMPLE

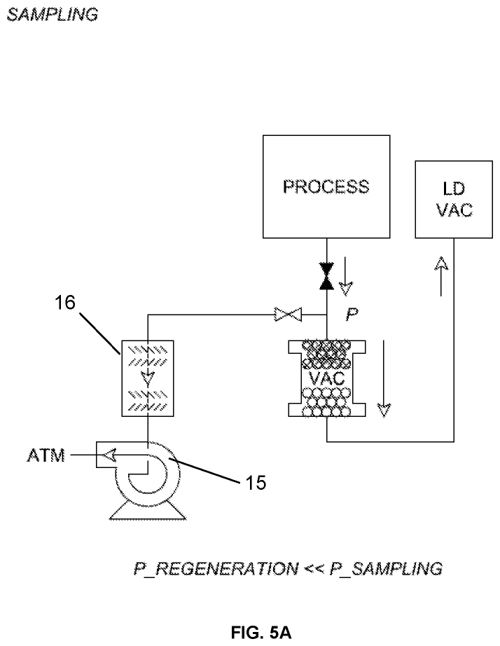

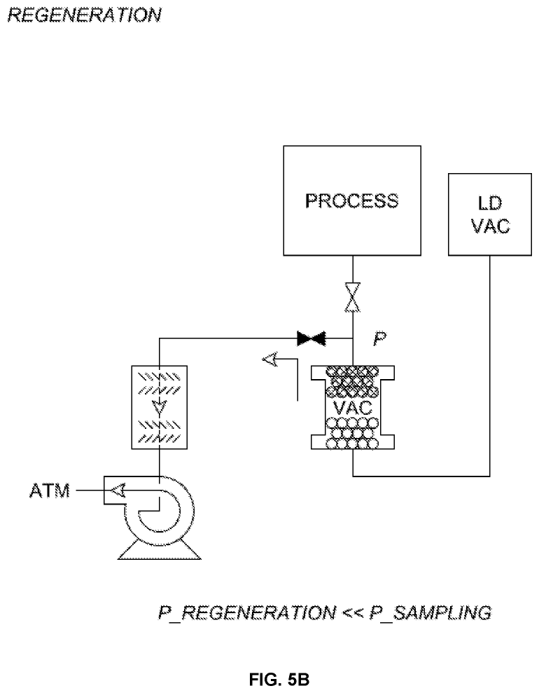

The system shown generally in FIG. 5 is configured for using a vacuum leak detector. The pump circuit comprises a mechanical pump 15 backing a turbomolecular vacuum pump 16. During sampling, FIG. 5A, all of the sample gas passes through the trap and on to the vacuum leak detector. Pressure in this flow path, P_{sampling}, is maintained at a selected level by the vacuum leak detector. Contaminants load the trap creating a “dirty” to “clean” gradient in the direction of flow. (The “dirty” side is indicated by shading of the sorbent particles in each of the FIGS.)

During regeneration, the vacuum leak detector is isolated from the process. A valve is opened allowing the turbomolecular vacuum pump to act directly on the trap reducing the pressure, P_{regeneration}, at the trap so that the adsorbed species will desorb from the dirty side of the trap and be extracted via the turbomolecular pump and its backing pump. Exemplary values of P_{sampling} range from 0.1 to 1 Torr, and P_{regeneration} from 0.001 to 0.01 Torr.

### EXAMPLE

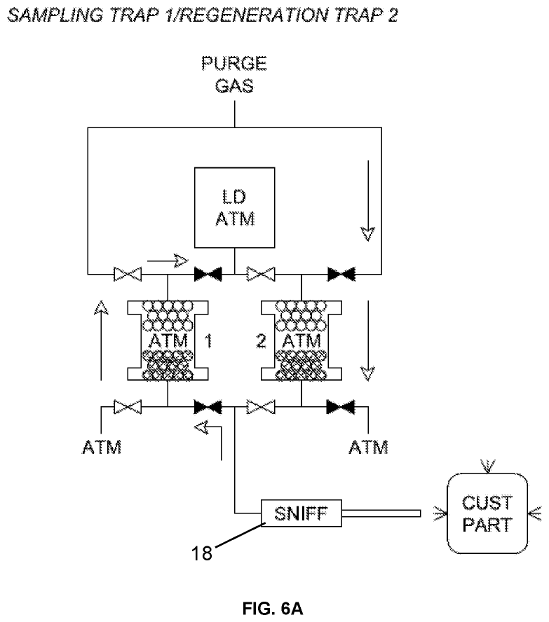

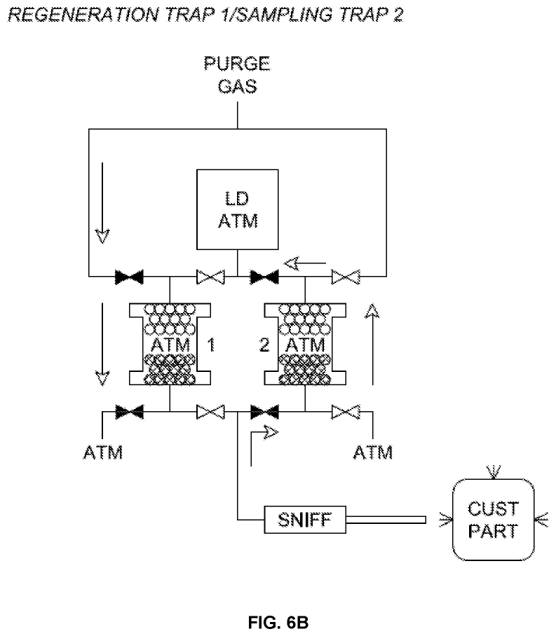

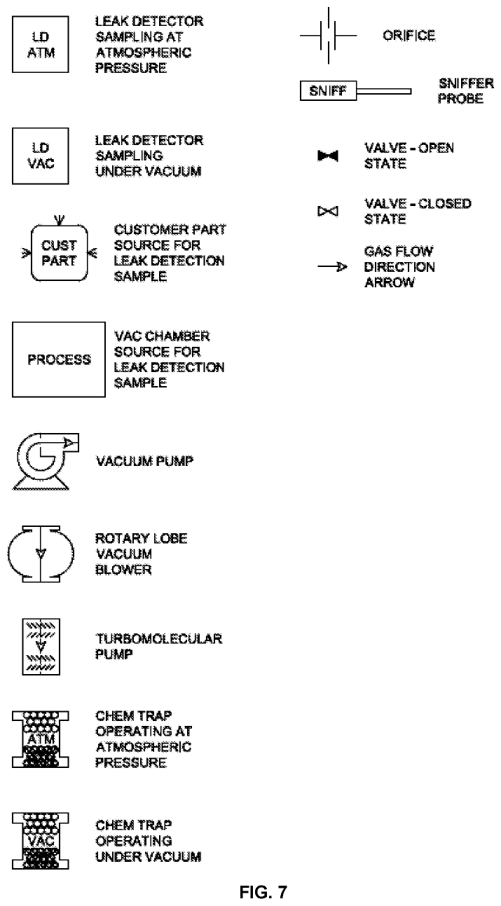

The system shown generally in FIG. 6 is intended for higher-throughput (i.e. continuous) testing with an atmospheric pressure leak detector and sniffer probe 18. The apparatus in this case is provided with two sorbent beds 1, 2 arranged in parallel so that periodically one sorbent bed may be regenerated while the other bed is in use while testing. FIG. 6A shows the flow paths for a run in which the sample stream is passing through trap 1 while trap 2 is being regenerated. During a sampling run, the pump of an atmospheric pressure leak detector extracts gas from the ambient air. The whole sample stream is directed to trap 1, the sample stream passing through the sorbent bed (or trap) and into an atmospheric pressure leak detector configured to detect the test gas. Traces of moisture, organics, or other interfering species are adsorbed by the sorbent bed, minimizing any false signal from these sources.

FIG. 6B shows the flow paths for the next run, in which the sample stream is passing through trap 2 while trap 1 is being regenerated. During the regeneration phase, FIG. 6B, the valve to the leak detector of trap 1 is closed and the purge gas valve is opened. Dry gas, which may optionally be heated, flows through the sorbent to desorb the adsorbed interfering species and carry them to atmosphere as shown.

The preceding examples, while not exhaustive, illustrate the flexibility of the invention to be configured for many practical leak tests. The following examples will describe in detail the results of testing some particular configurations.

### EXAMPLE

Using a Vacuum Technology, Inc., HounDog Leak Test Station for Leak Testing Refrigerant “A” Coils

A system was configured as generally described in FIG. 1.

System Hardware and Operating Details:

The test gas was R-410A vapor at 140 psig. The test reject flow rate was 1.0 oz/yr at 140 psig. The chamber was 17 cubic feet in volume. The test cycle time, not including load/unload was 70 seconds. The pumps used to remove air from the chamber before testing were a blower [model V2500, Aerzen USA, Coatesville, Pa.]/pump [model SV630, Leybold USA, Export, Pa.] combination. The sample pump was a Varian Model IDP 3 scroll pump [Agilent, Santa Clara, Calif.]. The chemical trap was installed on the exhaust of the Varian scroll pump and operated at atmospheric pressure. The chemical trap was connected to the inlet of the leak detector [model HLD 6000, INFICON, East Syracuse, N.Y.]. The trap was a 0.75 inch diameter tube, 0.5 inch long, filled with sSORB® silica gel pellets [Interra Global, Park Ridge, Ill.]. Regeneration was performed using dry compressed air as the purge gas between tests. The INFICON HLD 6000 leak detector is an infrared based atmospheric sniffer style leak detector.

Test Results:

Without the chemical trap, the background test signal from the chamber was equivalent to a 3 oz/yr refrigerant leak. Using the chemical trap lowered the background test signal from the chamber to 0.3 oz/yr. This dramatic 10:1 reduction in background can clearly improve sensitivity and/or reduce the cycle time at the same sensitivity.

### EXAMPLE

Hydrogen Large Chamber Testing for Refrigerant Slab Coils

A system was configured as generally described in FIG. 4.

System Hardware and Operating Details:

The test gas was 5% H₂ in N₂ gas at 650 psig. The test reject flow rate was 4×10⁻⁵ atm-cm³/s H₂ flow which is equivalent to a 0.5 oz/yr leak of R-410A at room temperature vapor pressure. The chamber was 169 cubic feet in volume. The test cycle time, not including load/unload was 300 seconds. The pumps used to remove air from the chamber before testing were an Aerzen V7000 blower backed by an Aerzen V2500 blower/SV630 pump combination. The detector was an INFICON LDS 3000 [INFICON, East Syracuse, N.Y.], which is a mass spectrometer based leak detector and was tuned to mass 2 for hydrogen. The chemical trap was installed between the Aerzen V2500 blower and the LDS 3000 leak detector and was operated under vacuum. The trap was 4 inch diameter tube, 10 inches long, filled with sSORB® silica gel pellets. Regeneration was performed by pumping on the end of the trap near the Aerzen V2500 blower using an OKTA 250 AM blower stand [Pfeiffer Vacuum, Inc., Nashua, N.H.]. Regeneration was performed between tests. The INFICON LDS 3000 has a built-in turbo molecular pump to draw in a gas sample for testing.

Test Results:

Without the chemical trap, the background test signal from the chamber was greater than 5 oz/yr refrigerant equivalent leak rate. With the chemical trap, the background test signal from the chamber dropped to 0.5 oz/yr. This 10:1 reduction in background can improve sensitivity and/or reduce the cycle time at the same sensitivity

Applicant had previously used a cryogenic trap for this application. The cryogenic trap requires a lower test pressure (the vacuum provides thermal insulation to the cold surface), so only a small fraction of the sample flow from the test chamber could be run to the cryogenic trap. Therefore the hydrogen signal measured with the cryogenic trap system was smaller than the chemical trap system. Comparing the chemical trap of the invention to the prior cryogenic trap showed several clear advantages:
1. The chemical trap does not have the maintenance issues that a cryogenic cold trap has.
2. The chemical trap does not require four hours of downtime for weekly regeneration like a cryogenic trap. The chemical trap is rapidly and automatically regenerated between test cycles.
3. For the same sized leak, the chemical trap configuration had a signal to the leak detector that was 7 times higher than when using a cryogenic trap. The higher signal means better detection.
4. The background signal from the chamber was 4 times smaller for the chemical trap than for the cryogenic trap which improves detection of small leaks.
5. The test time using the chemical trap was faster than using the cryogenic trap: In this example the cycle time with this chemical trap was 20 seconds faster than the cycle time with the cryogenic trap, which represents a 7% reduction in cycle time.

### EXAMPLE

Hydrogen Small Chamber Testing for Air Bag Inflators

A system was configured as generally described in FIG. 5.

System Hardware and Operating Details:

The test gas was 5% H₂ in Ar at 6000 psig. The test reject flow rate was 1×10⁻⁷ atm-cm³/s hydrogen flow. The chamber was about 100 cubic centimeters. The test cycle time, not including load/unload, was 21 seconds. The pump used to remove air from the chamber before testing was a Pascal 2021i [Pfeiffer/Adixen Nashua, N.H.]. The detector was an INFICON LDS 3000 which is a mass spectrometer based leak detector and was tuned to mass 2 for hydrogen. The chemical trap was installed between the chamber and the INFICON LDS 3000 leak detector and was operated under vacuum. The trap was a 1.5 inch diameter tube, 5 inches long filled with sSORB® silica gel pellets. Regeneration was performed by pumping on the dirty side of the trap near the chamber using a Pfeiffer TMU071 turbomolecular pump between tests. The INFICON LDS 3000 has a built-in turbo molecular pump used to draw in a gas sample.

Test Results:

The hydrogen test signal from the chamber testing parts was 3×10⁻⁷ atm-cm³/s without the chemical trap. This is three times larger than the reject flow rate which would make hydrogen testing infeasible without a trap. With the chemical trap, the hydrogen part test signal from the chamber dropped to 4×10⁻⁸ atm-cm³/s. This 8:1 reduction in background can yield improved sensitivity and/or a reduction in cycle time at the same sensitivity.

### EXAMPLE

Trapping System for Sniffer Leak Detection

A system was configured as generally described in FIG. 6.

System Hardware and Operating Details:

The test gas was 5% H₂ in N₂ at 150 psig. The test reject flow rate was 1.7×10⁻⁸ atm-cm³/s hydrogen flow which is equivalent to a 0.25 oz/yr of R-410A refrigerant at room temperature vapor pressure. The test involved manually sniffing a part filled with test gas to pin point leaks. The dual chemical trap assembly was installed between the part being sniffed and the H2HS-PRO [Vacuum Technology, Inc., Oak Ridge, Tenn.] which is a mass spectrometer based, sniffer leak detector. Two traps 1, 2 were used, one in test and one being regenerated. The traps were 0.75 inch diameter tubes, 0.5 inch long filled with sSORB® silica gel pellets. The traps were operated at near atmospheric pressure. Regeneration was performed using dry compressed air as the purge gas on the “clean” side of the trap near the leak detector out into the atmosphere. One trap was being regenerated while the other trap was stripping contaminants from the gas going to the sniffer leak detector. The system cycled between the traps about once per minute. The detector was tuned to mass 2 for hydrogen; it has a built-in turbo molecular pump used to draw in a gas sample. The detector was configured to operate in sniffing mode, drawing an air gas sample from near potential leaks on the part with a flow rate of 300 sccm.

Test Results:

Without the chemical trap, the hydrogen test signal from 100% relative humidity air was equivalent to a 0.6 oz/yr refrigerant leak. Using the chemical trap the signal attributable to water vapor dropped by a factor of more than 2:1.

Applicant contemplates that the aforedescribed system may be further improved by using a vacuum regeneration instead of a gas purge, thereby making the system more portable.

The inventive system provides a number of clear and surprising benefits over conventional methods:

U.S. Pat. No. 2,863,315, to Penning, describes a leak detector having a chilled adsorbing medium (at LN₂ temperature) between a H₂ or He detector and the part being leak checked. It is claimed that silica gel is preferable to activated carbon if H₂ is used as the test gas, whereas either medium can be used with He. In the present invention, the trap operates at ambient temperature and is rapidly regenerated at ambient temperature, which greatly reduces both system complexity/cost and cycle time.

U.S. Pat. No. 3,342,990 uses a sorption pump at LN₂ temperatures as a gas filter in front of a mass spectrometer. The sorption pump is used as a capture pump, like a cryo cold trap so the system will necessarily be down when it regenerates. The invention uses an adsorption trap at ambient temperature and this allows the user to regenerate it rapidly in the seconds between test cycles.

### EXAMPLE

Many suitable sorbents may be used in the inventive systems. Table 1 lists some examples; however it will be appreciated that this list is not intended to be exhaustive and that many of the exemplary products represent industrial commodities that are readily available in large quantities from many suppliers.)

TABLE 1
Some representative sorbent materials useful
for some aspects of the invention

| Material | Manufacturer | Product Identification |
|---|---|---|
| calcium | W. A. HammondDrierite | Drierite ® |
| sulfate | Co. Ltd. | |
| silica gel | Interra Global | sSORB ® silica gel pellets |
| | Delta Adsorbents | white silica gel |
| | | blue indicating silica gel |
| | | SorbeadTM Orange |
| | | CHAMELEON ® BASF |
| activated | Interra Global | aSORB ® alumina spheres |
| alumina | Sorbent Technologies, | Spheres, 7 × 14 Tyler |
| | Inc. | Mesh, 2.0 mm |
| | | Spheres, ⅛ in. (3.2 mm) |
| | Sorbent Media | 1/16 Inch mesh beads |
| | Delta Adsorbents | DelSORB ® AA 116B |
| | | DelSORB ® AA18B |
| | | DelSORB ® AA316B |
| | | DelSORB ® AA14B |
| | Union Alkalies and | Adsorbent (A-AS-04) |
| | Chemicals | |
| molecular | Delta Adsorbents | 3A molecular sieve |
| sieve | | 4A molecular sieve |
| | | 4A blue indicating |
| | | molecular sieve |
| activated | Evoqua Water | VOCARB ® 36C |
| carbon | technologies | VOCARB ® 46 |
| | | VOCARB ® 48C |
| | Calgon Carbon | AT 410 |
| | | Flexzorb ™ Activated Carbon |
| | | Cloth |
| | | AP4-60 Pelletized Activated |
| | | Carbon |

As shown in Table 1, some dessicant materials may be provided with a color indicator that changes from one color to another when the material reaches a certain moisture content. The trap may therefore be constructed of a transparent material, such as a glass or transparent plastic tube, or it may be a metal tube provided with a transparent sight port as is well known in the art, so that at any time a user may visually inspect the desiccant to evaluate the indicator color. Visual inspection can also detect any changes in the sorbent material, such as mechanical deterioration, excessive particle breakdown, or discoloration that might indicate the buildup of organic contaminants.

Those skilled in the art will appreciate that the trap may be optimized for particular applications by applying the principles of engineering and physical chemistry, along with the known properties of various sorbent materials and the different adsorption isotherms of particular gaseous species thereon. The critical attributes for configuring a trap for a particular leak detection problem include, inter alia, sorbent bed diameter, sorbent bed depth, pick up rate and release rate for a given combination of medium and tracer gas, off cycle regeneration, atmospheric vs. vacuum regeneration, and the use of multiple traps alternately to allow regeneration without measurement downtime. Multiple sizes and/or compositions of sorbents may be used to optimize the rate of flow through the chemical trap. For example, sorbent beads of two different diameters may be blended to provide a denser packing and minimize bypass flow around the beads. Furthermore, a stratified trap may be utilized in order to optimize trapping efficiency. Physical configuration of the chemical trap (i.e. length and/or diameter) may be varied to optimize flow.

In the preceding examples, it was generally contemplated that the sorbent trap is permanently installed in the system and regenerated in place. It will be appreciated, however, that the sorbent material may be provided in the form of an easily-replaceable cartridge, which may be disposable or may be regenerable. In such cases, the trap might be sized to accommodate a selected number of test runs, after which it is replaced by a fresh trap. The saturated trap may be discarded or it may be regenerated offline by baking or placing in a high vacuum environment. Alternatively, the trap may contain a reservoir of fresh sorbent, so that periodically the saturated sorbent is discharged into a container (for regeneration or disposal) and fresh sorbent is added to the trap. Applicant further contemplates that a two-stage trap may be useful when both water vapor and organics are potentially present as described in the following example.

### EXAMPLE

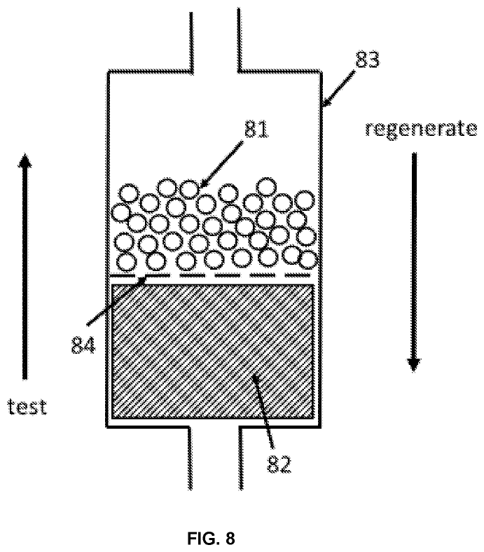

During long-term testing of a system in the presence of organic contaminants, Applicant observed that over time the sorbent beads became darkened. Because the adsorption of organics into the beads might reduce their ability to adsorb and desorb water, a second trapping stage may be added. The second trap is preferably a material that will efficiently capture volatile organic species in preference to water vapor (and in preference to the test gas) and is preferably placed in line ahead of the moisture trap in order to collect organics before they reach the moisture trap. FIG. 8 shows schematically in cross section a trap having a moisture trapping material 81 and an organic trapping material 82 all contained in a unitary housing 83. (Arrows indicate the direction of gas flow during testing and during regeneration.) Moisture trapping material 81 may comprise silica gel, activated alumina, calcium sulfate, or molecular sieve beads or granules, for example. Organic trapping material 82 may, for example, comprise activated carbon in any suitable form, such as granules, papers or felts, bonded carbon fiber composites, etc. A perforated separator 84 may be provided to prevent intermixing if, for example, both trapping materials are granular

### EXAMPLE

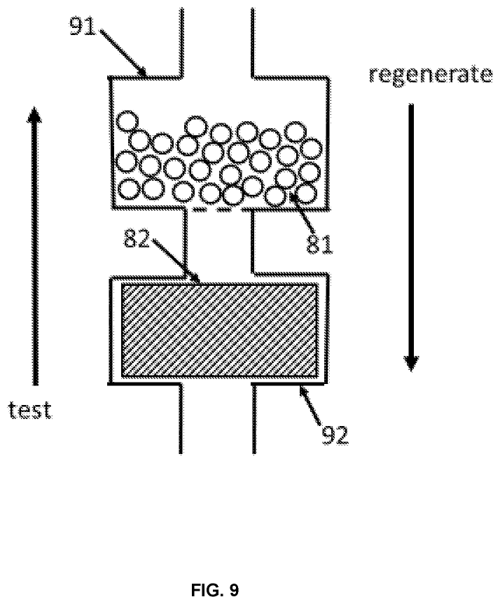

Applicant contemplates that depending on the amount and types of organic interfering species, the organic trapping material may not be as easily regenerated between tests as is the water trapping material, and for such applications the configuration shown schematically in FIG. 9 may be preferred. Here, moisture trapping material 81 and organic trapping material 82 are contained in separate housings 91 and 92, respectively.

In operation, the system may cycle between test and regeneration as in earlier examples; however, depending on the respective adsorption isotherms, the organic trapping material might not be regenerable under ambient temperature cycling. At the same time, there will typically be much more moisture than organic vapors in the test environment, so even though the gas flow is cyclic as described in the foregoing examples, in some cases the moisture trap will regenerate while the organic trap simply accumulates the impurities. By separating the two traps, the user is given several options to optimize the inventive process for a particular application:
1. The organic trap might be treated as a disposable item, to be used for a certain number of test cycles and then discarded.
2. The organic trap might be regenerable offline (by heating in a vacuum, for example), so a complete test system might include a single moisture trap and a few organic traps.
3. The number of spare organic traps may be adjusted based on the expected ratio of water vapor to volatile organics present in a particular test environment.

### EXAMPLE

It will be appreciated that the use of pure hydrogen gas presents safety issues because of the wide explosive limits (18-60%) and flammability limits (4-75%) of hydrogen in air. To mitigate the risk of unexpected combustion, mixtures such as Ar-4% H₂ and N₂-5% H₂ may be used in the inventive method, with the latter mixture generally preferred because of its lower cost. Other gas mixtures of H₂ with non-interfering gases such as CO₂ may be developed for particular applications through routine experimentation.

### EXAMPLE

Some suitable detectors include: the LDS 3000 Modular Leak Detector, the HLD 6000 sniffer probe (INFICON Holding AG, Switzerland), the quadrupole mass spectrometer/RGA(source), the Pfeiffer ASM340, the Ulvac Heliot 900, Leybold Phoenix L300i, the VIC MS-40, and the Varian/Agilent VS C15. Some suitable refrigerant detectors include: the Bacharach PGM-IR, and the Fieldpiece SRL2K7.

### EXAMPLE

Applicant has identified a number of particular leak detection techniques and tracer gas types for which the invention is particularly suited. Some of these tracer gases include: R-410A, R-134a, and other refrigerants as defined by ANSI/ASHRAE Standard 34-2019, Designation and Safety Classification of Refrigerants, incorporated herein by reference in its entirety

The invention may include a number of variants in structure and modes of operation. The following paragraphs describe some of these in summary form.

A system for detecting gas leaks in a gas-containing component, may comprise:

a test gas comprising molecular hydrogen introduced on one side of said gas-containing component;

a vacuum pump to collect a gas sample from the other side of said gas-containing component;

a hydrogen detector to receive said gas sample and determine the hydrogen content therein; and,

a trap containing a sorbent material upstream from said hydrogen detector, said sorbent material characterized by having less affinity for molecular hydrogen than for heavier hydrogen-containing molecular species and being capable of regeneration at ambient temperatures.

The test gas may comprise pure hydrogen or a mixture of hydrogen with an inert diluent gas. The inert diluent gas may be nitrogen, CO₂, or argon.

The sorbent material may comprise calcium sulfate dessicant, activated alumina, silica gel, activated charcoal, and inorganic molecular sieves including zeolites, porous glass, and clays, as well as combinations and mixtures thereof. The sorbent material may comprise granules of a selected size or a mixture of sizes, and may contain a visual (color) indicator that shows if the sorbent is saturated. The trap may comprise a housing that is at least partially transparent to allow a user to visually inspect the sorbent during use. The trap may further comprise a first bed of a first sorbent, and a second bed of a second sorbent. One or both beds may be disposable and/or at least partially regenerable.

The sorbent trap may be regenerated by exposure to flowing dry gas, or by exposure to a lower pressure than existed when the trap was operating to adsorb the other interfering species.

A plurality of traps may be provided in parallel and valves may be provided to direct sample gas through one trap while another trap is simultaneously being regenerated

A method for detecting leaks may comprise the steps of:

a) introducing a test gas comprising molecular hydrogen on one side of a gas-containing component;

b) using a vacuum pump to collect a gas sample from the other side of said gas-containing component;

c) passing said gas sample at ambient temperature through a trap containing a regenerable sorbent material, said sorbent material characterized by having less affinity for molecular hydrogen than for heavier hydrogen-containing molecular species, so that the concentration of said other species are reduced by adsorption relative to the concentration of molecular hydrogen; and,

d) passing said gas sample from said trap to a hydrogen detector.

The method may include the further step of isolating and regenerating the sorbent at ambient temperature to remove the adsorbed hydrogen-containing molecular species. The regeneration may be accomplished by exposing the sorbent to dry gas, or by exposing the sorbent to a lower total pressure than existed during the test cycle.

The method may include providing a plurality of traps so that one trap may be regenerated while another is in use.

The test gas may comprise pure hydrogen or a mixture of hydrogen with an inert diluent gas. The inert diluent gas may be nitrogen, CO₂, or argon.

The sorbent material may comprise calcium sulfate dessicant, activated alumina, silica gel, activated carbon, and inorganic molecular sieves including zeolites, porous glass, and clays, as well as combinations and mixtures thereof.

According to another aspect of the invention, a system for detecting gas leaks in a gas-containing component, comprises:

a test gas comprising a selected refrigerant introduced on one side of a gas-containing component;

a vacuum pump to collect a gas sample from the other side of the gas-containing component;

a refrigerant detector to receive the gas sample and determine the test gas content therein; and,

a trap containing a regenerable sorbent material upstream from the detector, the sorbent material characterized by having less affinity for the selected refrigerant than for heavier organic molecular species and being capable of regeneration at a selected temperature.

The test gas may comprise a refrigerant gas as defined by ASHRAE. ASHRAE Standard 34 establishes a uniform system for assigning reference numbers, safety classifications, and refrigerant concentration limits to refrigerants. The standard also identifies requirements to apply for designations and safety classifications for refrigerants and to determine refrigerant concentration limits. Safety classifications based on toxicity and flammability data are included along with refrigerant concentration limits for the refrigerants.

The sorbent material may comprise calcium sulfate dessicant, activated alumina, silica gel, activated carbon, and inorganic molecular sieves including zeolites, porous glass, and clays, as well as combinations and mixtures thereof. The sorbent material may further contain a visual indicator of its state of saturation.

The refrigerant detector may detect the test gas by measuring the IR absorption over a selected wavelength range.

According to another aspect of the invention, a method for detecting leaks comprises the steps of:

a) introducing a test gas comprising a selected refrigerant on one side of a gas-containing component;

b) using a vacuum pump to collect a gas sample from the other side of the gas-containing component;

c) passing the gas sample through a trap containing a regenerable sorbent material, the sorbent material characterized by having less affinity for the selected refrigerant than for at least one interfering molecular species, so that the concentration of the interfering species are reduced relative to the concentration of the selected refrigerant; and,

d) passing the gas sample from the trap to a refrigerant detector.

The method may further include the step of e) regenerating the sorbent material. The sorbent may be regenerated by exposing the sorbent to dry gas, or by exposing the sorbent to a lower total pressure than existed during the test cycle.

As used herein, the term ambient temperature is understood to be generally synonymous with “room temperature” and in the present context it implies a range of temperature customarily encountered in a laboratory or factory environment. Such temperatures are commonly in the range of 15-25° C. or 59-77° F., with excursions to perhaps 30° C. In the context of the inventive method, a trap operating “at ambient temperature” is one that is neither actively heated nor cryogenically cooled; in other words, the trapping and regeneration steps are carried out at substantially the same temperature.

As used herein, the term “rapidly” when applied to regeneration is understood to generally be within the cycle time of the particular application considered in the example. In practice, this can be less than 10 minutes, less than 1 minute, or less than 20 seconds depending on the size of the test system.

As used herein, the term “dry” as used with compressed air for purge gas is understood to be air with a dew point of −40° C., or lower.

We claim:

1. A system for detecting gas leaks in a gas-containing component, comprising:
a test gas comprising molecular hydrogen introduced on one side of said gas-containing component;
a vacuum pump to collect a gas sample from the other side of said gas-containing component;
a hydrogen detector to receive said gas sample and determine the hydrogen content therein; and,
a trap containing a sorbent material upstream from said hydrogen detector, said sorbent material characterized by having less affinity for molecular hydrogen than for other hydrogen-containing molecular species and being capable of both sorption and regeneration at ambient temperatures.

2. The system of claim 1 wherein said test gas comprises a gas selected from the group consisting of: pure hydrogen, and mixtures of hydrogen with an inert diluent gas selected from the group consisting of: nitrogen, CO₂, and argon.

3. The system of claim 1 wherein said sorbent material comprises a material selected from the group consisting of: calcium sulfate dessicant, activated alumina, silica gel, activated carbon, and inorganic molecular sieves including zeolites, porous glass, clays, and combinations and mixtures thereof.

4. The system of claim 1 wherein said sorbent material comprises granules of one or more selected sizes.

5. The system of claim 1 wherein said sorbent material further contains a visual color indicator that shows if said sorbent is saturated.

6. The system of claim 1 wherein said trap comprises a housing that is at least partially transparent so that said sorbent may be visually inspected during use.

7. The system of claim 1 wherein said trap further comprises a first bed of a first sorbent, and a second bed of a second sorbent, and at least one of said first and second sorbents is regenerable.

8. The system of claim 1 wherein said sorbent material may be regenerated by a method selected from the group consisting of:
exposure to flowing dry gas, and,
exposure to a lower pressure than existed when the trap was operating to adsorb said heavier hydrogen-containing molecular species.

9. The system of claim 1 further comprising a plurality of identical traps arranged in parallel, with valves configured to direct sample gas through one of said identical traps while another of said identical traps is simultaneously being regenerated

10. The system of claim 1 wherein said trap comprises a first stage containing a first sorbent material and a second stage containing a second sorbent material, and at least one of said first and second sorbent materials is capable of regeneration at ambient temperatures.

11. A method for detecting leaks comprises the steps of:
a) introducing a test gas comprising molecular hydrogen on one side of a gas-containing component;
b) using a vacuum pump to collect a gas sample from the other side of said gas-containing component;
c) passing said gas sample at ambient temperature through a trap containing a regenerable sorbent material, said sorbent material characterized by having less affinity for molecular hydrogen than for other hydrogen-containing molecular species, so that the concentration of said other species are reduced by adsorption relative to the concentration of molecular hydrogen; and,
d) passing said gas sample from said trap to a hydrogen detector.

12. The method of claim 11 further including the step of e) isolating and regenerating said sorbent at ambient temperature to remove said adsorbed heavier hydrogen-containing molecular species.

13. The method of claim 12 wherein said regeneration step is accomplished by a method selected from the group consisting of:
exposing said sorbent to dry gas, and,
exposing said sorbent to a lower total pressure than existed during the test cycle.

14. The method of claim 11 further including the step of f) providing a plurality of traps with valves arranged so that one trap may be regenerated while another is in use.

15. The method of claim 11 wherein said test gas comprises a gas selected from the group consisting of: pure hydrogen, and mixtures of hydrogen with an inert diluent gas selected from the group consisting of: nitrogen, CO₂, and argon.

16. The method of claim 11 wherein said sorbent material comprises a material selected from the group consisting of: calcium sulfate dessicant, activated alumina, silica gel, activated carbon, and inorganic molecular sieves including zeolites, porous glass, clays, and combinations and mixtures thereof.

17. The method of claim 11 wherein said trap comprises a first stage containing a first sorbent material and a second stage containing a second sorbent material, and at least one of said first and second sorbent materials is capable of regeneration at ambient temperatures.

18. The method of claim wherein said first stage and said second stage are contained in separate housings.

19. The method of claim 17 wherein at least one of said first and said second sorbent materials is disposable when saturated.
